(19) United States
(12) Patent Application Publication
(10) Pub. No.: US 2013/0119661 A1
(43) Pub. Date: May 16, 2013

(54) Horizontal Axis Radial Wind Turbine

(71) Applicants: Frank G. Pringle, Marlton, NJ (US); George P. Birch, Coatesville, PA (US)

(72) Inventors: Frank G. Pringle, Marlton, NJ (US); George P. Birch, Coatesville, PA (US)

(73) Assignee: 888 CORPORATION, Marlton, NJ (US)

(21) Appl. No.: 13/463,146

(22) Filed: May 3, 2012

Related U.S. Application Data
(63) Continuation-in-part of application No. PCT/US2010/055239, filed on Nov. 3, 2010.
(60) Provisional application No. 61/257,578, filed on Nov. 3, 2009.
(60) Provisional application No. 61/485,613, filed on May 12, 2011.

(51) Int. Cl. F03D 3/04; F03D 3/00; F03D 9/00

(52) U.S. Cl. CPC F03D 3/0418; F03D 9/002; F03D 3/002
USPC 290/44; 290/55

(57) ABSTRACT

A wind turbine and housing combination may include a horizontal axis radial wind turbine and a housing surrounding the turbine, the housing being incorporated with a cupola or gable roof of a building. The turbine may include an axle, a plurality of blade sections extending radially from the axle, and a generator operatively coupled to a first end of the axle. Each blade section may include a curved drag surface that provides a stall surface normal to the direction of an anticipated wind flow. The generator may be adapted to produce electricity when the axle is rotated. The housing may include a plurality of louvers and a motor operatively coupled to the plurality of louvers. Each louver may be capable of having (i) a closed position that prevents wind from entering the housing and (ii) an open position that permits wind to enter the housing. The housing may be adapted to be attached to an apex of a gable roof of a building.

### CROSS REFERENCE TO RELATED APPLICATIONS

This application is a continuation-in-part of U.S. patent application no. PCT/US2010/055239, filed Nov. 3, 2010, which claims the benefit of priority to U.S. Patent Application No. 61/257,578, filed Nov. 3, 2009, the entireties of which are hereby incorporated by reference. This application also claims the benefit of priority to U.S. provisional application No. 61/485,613, filed on May 12, 2011, the entirety of which is incorporated by reference herein for all purposes.

### TECHNICAL FIELD

The present invention generally relates to wind turbines for generating electricity from wind and solar energy. More particularly, the present invention relates to horizontal axis radial wind turbines that are adapted to be placed on the apex of a gable roof of a building.

### BACKGROUND

Roof-based wind turbines are well known in wind energy industries as generating rotational motion from the wind to produce electricity for use in a building or residence.

Conventional roof-based wind turbines are typically configured to be most efficient at high wind speeds, for example, approximately 30 miles per hour. Conventional roof-based turbines may be less efficient at low wind speeds, for example, between zero and 10 miles per hour. Conventional roof-based turbines may also produce excessive vibration, partially because of the high wind speeds necessary to achieve peak efficiency. Excessive vibration may lead to excessive operational noise, which may be a nuisance for a homeowner or neighbors of the homeowner. Conventional roof-based turbines may also be expensive, which may reduce the ability of a conventional turbine to recover the capital expenditure cost with energy savings in a reasonable period of time.

It is desirable to develop an improved roof-based wind turbine system that has improved performance compared to the designs in the prior art.

### SUMMARY

Provided herein are wind turbine and housing combinations, methods of harnessing energy from a wind field, and wind turbine systems. Wind turbine and housing combinations provided herein comprise a horizontal axis radial wind turbine, the turbine including: an axle; a plurality of blade sections extending radially from the axle, the blade sections circumferentially spaced about the axle, each blade section including a curved drag surface that provides a stall surface normal to the direction of an anticipated wind flow; and a generator operatively coupled to a first end of the axle, the generator adapted to produce electricity when the axle is rotated; and a housing surrounding the turbine, the housing including: a plurality of louvers, each louver coupled to the louver frame, each louver pivotable relative to the housing, each louver capable of having (i) a closed position that prevents wind from entering the housing and (ii) an open position that permits wind to enter the housing; and a motor operatively coupled to the plurality of louvers, the motor adapted to move each louver between the closed position and the open position; whereby the housing is adapted to be attached to an apex of a gable roof of a building.

A wind turbine and housing combination provided herein comprises a horizontal axis radial wind turbine generator, a housing surrounding the wind turbine generator, the housing comprising a plurality of louvers operably coupled to the housing and capable of being opened and closed in response to wind and temperature conditions, wherein the louvers direct wind currents, thermal air currents, or both to turn the radial wind turbine generator.

Methods of harnessing energy from a wind field comprise: attaching a radial wind turbine to an apex of a gable roof of a building; opening one or more of a plurality of louvers coupled to a housing surrounding the turbine by actuating the motor; rotating a plurality of blade sections extending radially from an axle of the turbine, the axle oriented substantially parallel to a longitudinal axis of the apex of the gable roof, the blade sections circumferentially spaced about the axle, each blade section including a curved drag surface that provides a stall surface normal to the direction of wind flow; and producing electricity from the rotation of the plurality of blade sections by driving a generator operatively coupled to a first end of the axle.

A method of harnessing energy from wind, thermal currents, or both, the method comprises positioning one or more of a plurality of louvers coupled to a housing surrounding a radial wind turbine generator in response to wind and temperature conditions, directing wind, thermal air currents, or both, through the position of the louvers to rotate a plurality of blade sections extending radially from an axle of the radial wind turbine, and generating electricity from the rotation of the radial wind turbine.

Wind turbine systems comprise: a horizontal axis radial wind turbine, the turbine including: an axle; a plurality of blade sections extending radially from the axle, the blade sections circumferentially spaced about the axle, each blade section including a curved drag surface that provides a stall surface normal to the direction of an anticipated wind flow; and a generator operatively coupled to a first end of the axle, the generator adapted to produce electricity when the axle is rotated; a housing surrounding the turbine and adapted to be attached to an apex of a gable roof of a building, the housing including: a plurality of louvers, each louver coupled to the louver frame, each louver pivotable relative to the housing, each louver capable of having (i) a closed position that prevents wind from entering the housing and (ii) an open position that permits wind to enter the housing; and a motor operatively coupled to the plurality of louvers, the motor adapted to move each louver between the closed position and the open position; and the gable roof of the building; whereby a first louver and a second louver of the plurality of louvers are adapted to form a channel to direct a thermal air current flowing along the gable roof into an underside of the turbine.

In additional embodiments there are provided wind turbine and housing combinations, comprising: a horizontal axis radial wind turbine, the turbine including: an axle; a plurality of blade sections extending radially from the axle, the blade sections circumferentially spaced about the axle, each blade section including a curved drag surface that provides a stall surface normal to the direction of an anticipated wind flow; and a generator operatively coupled to a first end of the axle, the generator adapted to produce electricity when the axle is rotated; and a housing surrounding the turbine, the housing including: a plurality of louvers, each louver coupled to the louver frame, each louver pivotable relative to the housing, each louver capable of having (i) a closed position that prevents wind from entering the housing and (ii) an open position that permits wind to enter the housing; and a motor operatively coupled to the plurality of louvers, the motor adapted to move each louver between the closed position and the open position; whereby the wind turbine is adapted to be incorporated within a cupola or a gabled roof of a building.

In additional embodiments there are provided methods of harnessing energy from a wind field, the method comprising: opening one or more of a plurality of louvers coupled to a housing surrounding the turbine by actuating the motor, the housing being integrated with a cupola or a gable roof of a building; rotating a plurality of blade sections extending radially from an axle of the turbine using the wind field, the axle oriented substantially parallel to a longitudinal axis of the apex of the gable roof, the blade sections circumferentially spaced about the axle, each blade section including a curved drag surface that provides a stall surface normal to the direction of wind flow; and producing electricity from the rotation of the plurality of blade sections by driving a generator operatively coupled to the axle.

In additional embodiments there are provided wind turbine systems, comprising: a horizontal axis radial wind turbine, the turbine including: an axle; a plurality of blade sections extending radially from the axle, the blade sections circumferentially spaced about the axle, each blade section including a curved drag surface that provides a stall surface normal to the direction of an anticipated wind flow; and a generator operatively coupled to a first end of the axle, the generator adapted to produce electricity when the axle is rotated; a housing surrounding the turbine and integrated with a cupola or a gable roof of a building, the housing including: a plurality of louvers, each louver coupled to the louver frame, each louver pivotable relative to the housing, each louver capable of having (i) a closed position that prevents wind from entering the housing and (ii) an open position that permits wind to enter the housing; and a motor operatively coupled to the plurality of louvers, the motor adapted to move each louver between the closed position and the open position, and the cupola or gable roof of the building; whereby a first louver and a second louver of the plurality of louvers are adapted to form a channel to direct a thermal air current flowing along the gable roof into an underside of the turbine.

In additional embodiments there are provided wind turbine and housing combinations, comprising: a horizontal axis radial wind turbine generator; a housing surrounding the radial wind turbine generator, the housing being incorporated with a cupola or gable roof of a building, the housing comprising a plurality of louvers operably coupled to the housing and capable of being opened and closed in response to wind and temperature conditions, wherein the louvers direct wind currents, thermal air currents, or both to turn the radial wind turbine generator.

In additional embodiments there are provided method of harnessing energy from wind, thermal currents, or both, the method comprising: positioning one or more of a plurality of louvers coupled to a housing surrounding a radial wind turbine generator in response to wind and temperature conditions, the housing being incorporated with a cupola or gable roof of a building; directing wind, thermal air currents, or both, through the position of the louvers to rotate a plurality of blade sections extending radially from an axle of the radial wind turbine; and generating electricity from the rotation of the radial wind turbine.

These and various other advantages and features are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there are illustrated and described preferred embodiments of the invention.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawings:

FIG. 1A is a perspective view of a first embodiment wind turbine and housing combination, attached to an apex of a gable roof of a building;

FIG. 1B is a perspective view of a pair of wind turbine and housing combinations depicted in FIG. 1A, attached to an apex of a gable roof of a building;

FIG. 2A is a perspective view of a horizontal axis radial wind turbine and lover frame suitable for use in the wind turbine and housing combination depicted in FIG. 1A;

FIG. 2B is a side view of the wind turbine depicted in FIG. 2A;

FIG. 3A is an end view of a second embodiment wind turbine and housing combination, attached to an apex of a gable roof of a building;

FIG. 3B is a perspective view of a louver frame and housing roof design suitable for use in the wind turbine and housing combination depicted in FIG. 3A;

FIG. 4A is a perspective view of a third embodiment wind turbine and housing combination;

FIG. 4B is an end view of the wind turbine and housing combination depicted in FIG. 4A;

FIG. 4C is a perspective view of another embodiment of a wind turbine integrated within a gable roof of a building, such as in new home construction;

FIG. 5A is cross sectional end view of another embodiment of a wind turbine integrated within a cupola of a building which shows the details of the louvers and louver actuators;

FIG. 5B is a cross sectional end view of another embodiment of a wind turbine integrated within a cupola of a building which shows the details of certain louvers directed into the cupola to give rise to greater turbine rotational speed;

FIG. 6 is a cross sectional end view of another embodiment of a wind turbine integrated within a cupola of a building which shows the details of certain louvers directed into the cupola to give rise to greater turbine rotational speed;

FIG. 7 is a cross sectional end view of another embodiment of a wind turbine integrated within a gable roof of a building which shows the details of certain louvers directed into the gable roof to give rise to greater turbine rotational speed; and

FIG. 8 is a cross sectional end view of another embodiment of a wind turbine integrated within a gable roof of a building which shows the details of certain louvers directed into the roof to give rise to greater turbine rotational speed.

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. Further, reference to values stated in ranges include each and every value within that range.

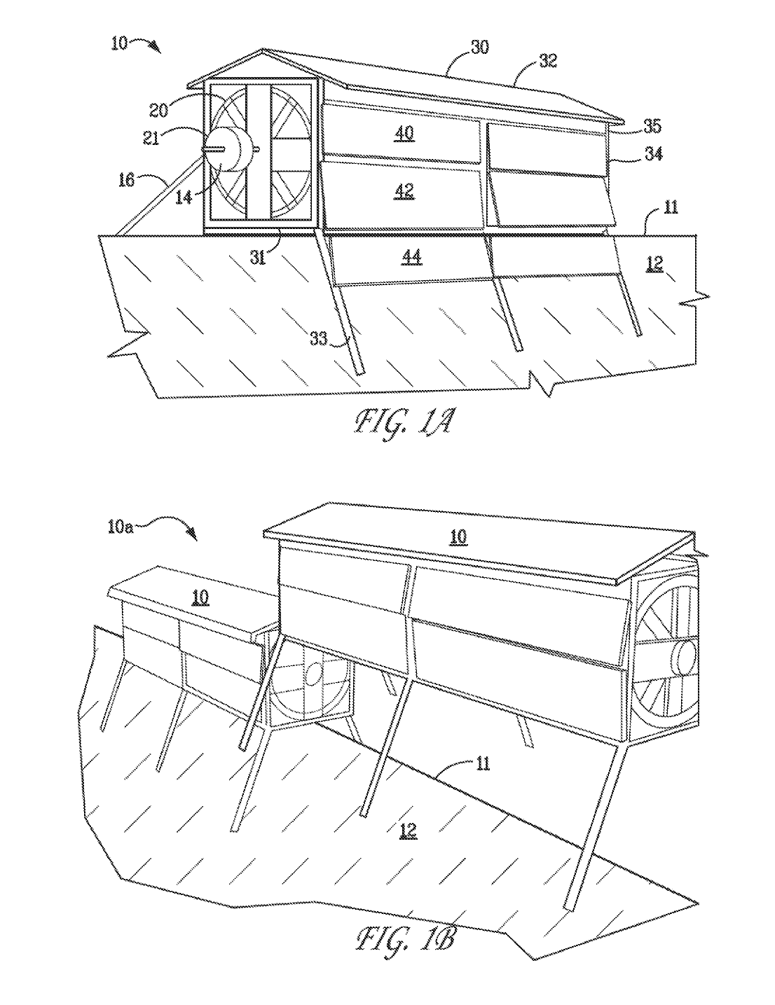

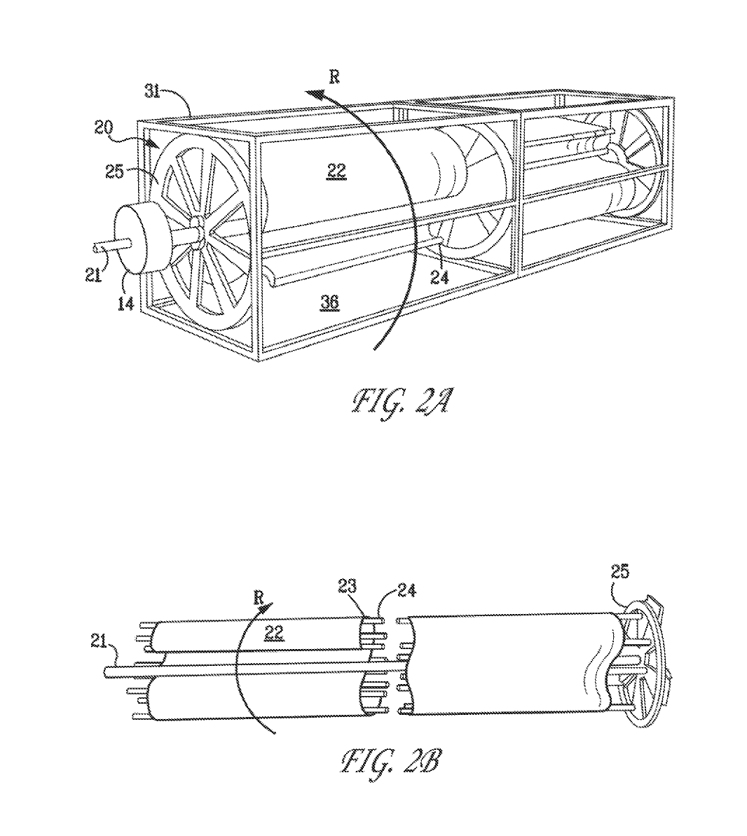

Referring to FIG. 1A, a first embodiment wind turbine and housing combination 10 includes a horizontal axis radial wind turbine 20 and a housing 30 surrounding the turbine 20.

The turbine 20 rotates about an axle 21 that is oriented horizontally with respect to the ground. As shown in the figures, the axle 21 is oriented substantially parallel to a longitudinal axis of an apex 11 of a gable roof 12 of a building. In other embodiments, the axle 21 may be oriented non-parallel to the longitudinal axis of the apex 11 of the gable roof 12, for example, if the apex 11 of the gable roof 12 is not substantially parallel to the ground.

The turbine 20 includes a generator 14 operatively coupled to a first end of the axle 21. The generator 14 is adapted to produce electricity when the axle 21 is rotated. The generator may be any type of commercially-available generator suitable for use in wind turbines, such as available from Ginlong Technologies (www.ginlong.com). Various types of generators are suitably used and are capable of operating up to 400 rpms. The generator is coupled to an electricity delivery line 16 for transmission of the electricity produced to the building to which the combination 10 is attached. The electricity produced by the combination 10 may be sufficient to provide all electrical power to the building, or the electricity produced by the combination 10 may supplement the electricity provided by other means, such as a local utility provider. In some embodiments, the turbine 20 may include a first generator 14 operatively coupled to a first end of the axle 21, and the turbine 20 may include a second generator 14 operatively coupled to a second end of the axle 21 opposite the first end of the axle 21.

Many other types of generators can be used, such as but not limited to permanent magnet DC generators, which generators can operate at shaft rpms of up 2500 rpm. Suitable generators are available from www.windstreampower.com. High rpms can be achieved in such generators using the wind tubines described herein using a suitable gearing combination connecting the turbine axel to the shaft of the generator. For example, a 100 tooth sprocket attached to the turbine axle that is coupled to a 20 tooth gear on the generator shaft gives rise to a five-fold increase in the rpm of the generator compared to the rpm of the turbine blades. Many other combinations of sprockets and gears can be used to increase to increase generator shaft speed up to 2500 rpm from a wind turbine rotating at approximately 100 rpm.

The housing 30 surrounds the turbine 20 and is attached to the roof 12 of a building. The housing 30 includes a louver frame 31, a housing roof 32, housing attachment brackets 33 for coupling the housing 30 to the gable roof 12, and a plurality of louvers 34 each coupled to the louver frame 31 at a pivot 35. The louvers 34 control the flow of air in and out of the housing. In this way, the louvers 34 are configured to be positioned in such a way so that wind flow and thermal currents may be directed into and out of housing 30 and may be compressed in housing 30, thereby increasing the force of the airflow on the turbine 20. The louvers also minimize the flow of airborne dirt and grime that would otherwise be deposited on the turbine 20. As shown in the figures, the housing 30 includes twelve louvers 34, six on each side of the housing 30. The twelve louvers 34 include four primary upper louvers 40, four secondary upper louvers 42 located vertically below the primary upper louvers 40, and four lower louvers 44 located vertically below the secondary upper louvers 42 and the turbine 20 and adapted to be positioned adjacent to an exterior surface of the gable roof 12. In some embodiments, either the primary upper louvers 40 or the secondary upper louvers 42 may be omitted, such that there is only one set of upper louvers, rather than two sets.

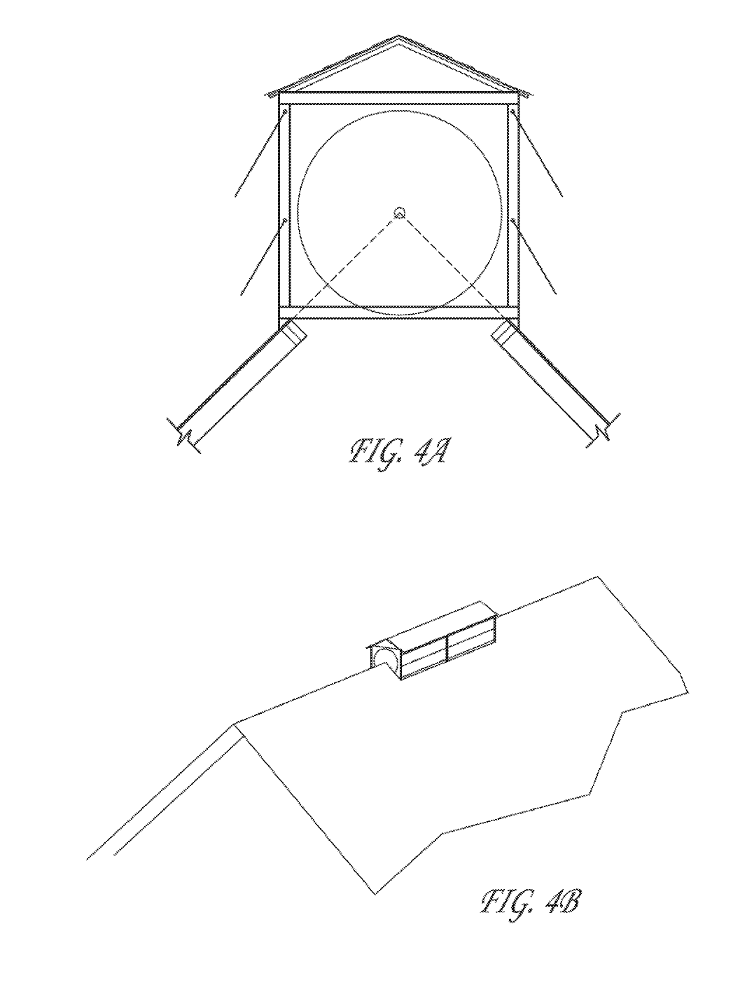

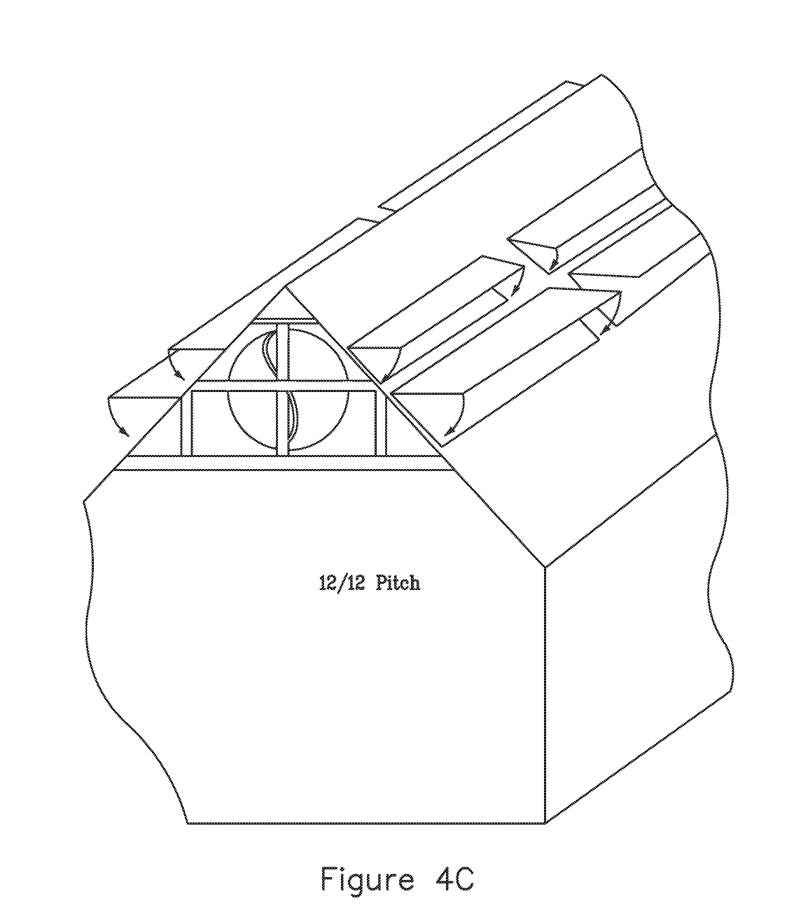

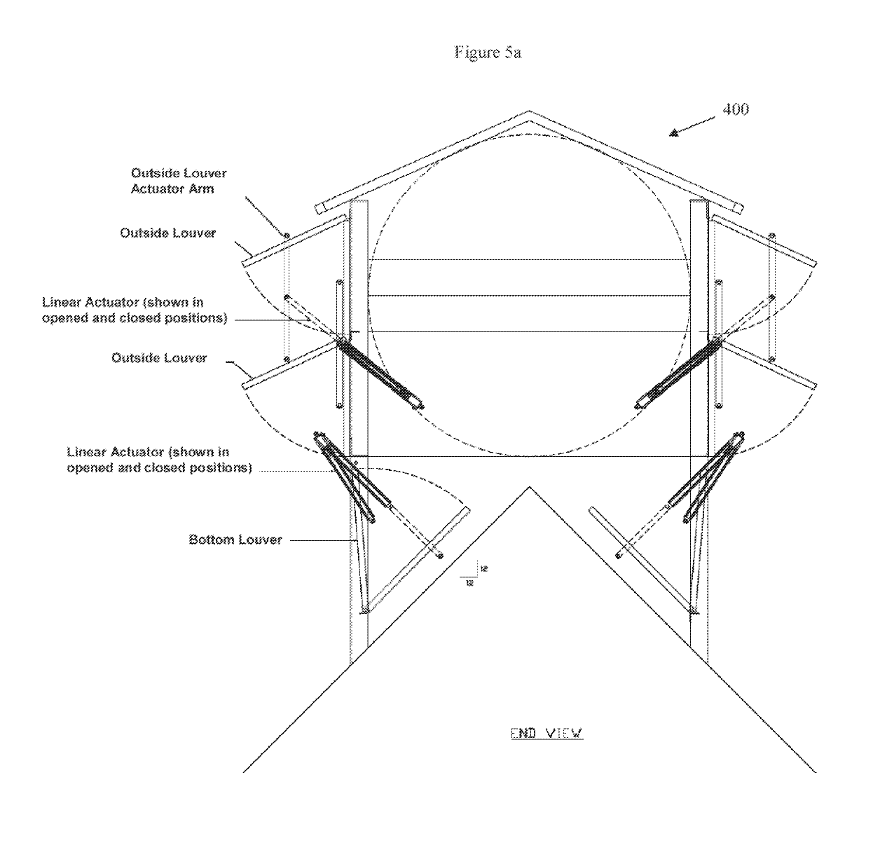

In an alternative embodiment, shown in FIGS. 4A and 4B, up to 40 percent of the turbine 20 is below the level of the apex 11 of the gable roof 12 of a building. This embodiment may include additional louvers 34 to control the flow of air from the building itself. Air that flows from the building may include hot air that may come from a hot attic or upper portion of the building. In this embodiment, the lower set of louvers 144 (shown in FIG. 3A) are not included and can be located beneath the roof.

Each louver 34 is pivotable relative to the louver frame 31 by rotation about the pivot 35. Each pivot 35 extends along a respective louver 34 and is substantially parallel to the axle 21. Each louver 34 is capable of having (i) a closed position that prevents wind from entering the housing 30 and (ii) an open position that permits wind to enter the housing 30 such that the wind can turn the turbine 20. Each louver 34 can be moved or actuated between the closed position and an open position by one or more motors (not shown) that are operatively coupled to each of the plurality of louvers 34.

Referring to FIG. 1B, a wind turbine system 10a includes a plurality of wind turbine and housing combinations 10. As shown in FIG. 1B, each wind turbine and housing combination 10 may be placed in an end-to-end configuration along the apex 11 of the gable roof 12 of a building. Each wind turbine and housing combination 10 may include a generator 14 operatively coupled to a first end of its axle 21. Each generator 14 may be coupled to one or more electricity delivery lines 16 for transmission of the electricity produced to the building to which the combinations 10 are attached.

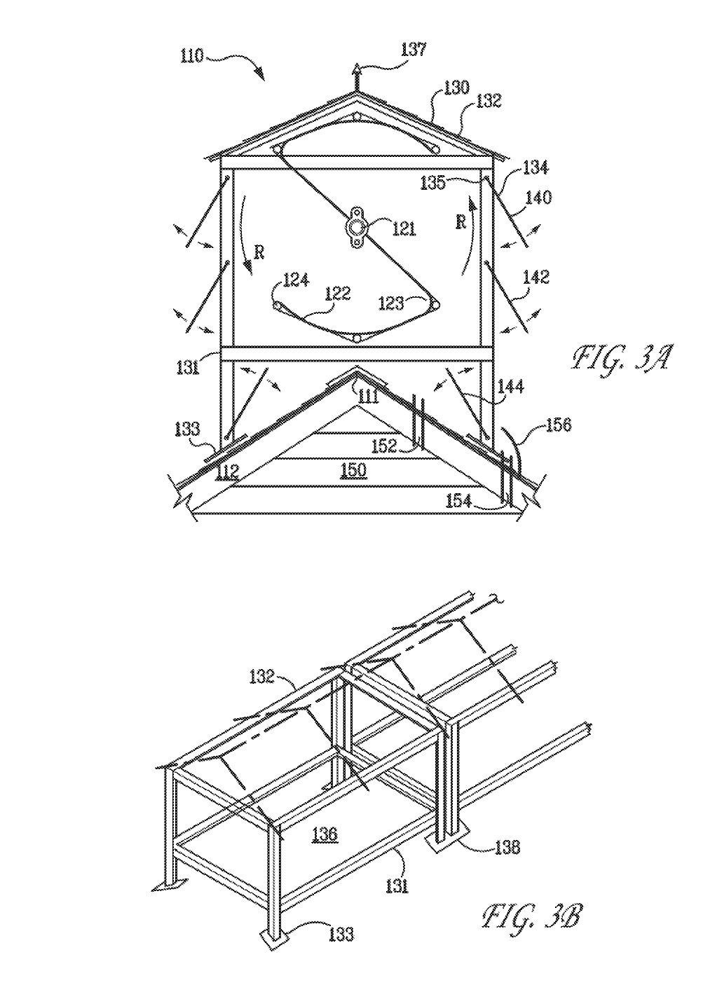

Referring to FIG. 2A, the louver frame 31 includes one or more compartments 36, each compartment 36 surrounding a portion of the turbine 20. As shown in the figures, the louver frame 31 has two compartments 36, each compartment 36 surrounding approximately half of the turbine 20. In other embodiments, the louver frame 31 may have any number of louver compartments 36, including for example, a single louver compartment 36 surrounding the entire turbine 20, or four louver compartments 36, each louver compartment 36 surrounding approximately one-quarter of the turbine 20.

Referring to FIGS. 2A and 2B, The turbine 20 further includes a plurality of blade sections 22 extending radially from the axle 21. The blade sections 22 are circumferentially spaced about the axle 21, each blade section 22 including a curved drag surface 23 that provides a stall surface normal to the direction of an anticipated wind flow. Each blade section 22 preferably is made from a lightweight fabric, such as nylon. Each blade section 22 may be made from any other material that can be oriented in the desired shape and that is capable of providing a curved drag surface 23 normal to the direction of an anticipated wind flow.

Each blade section 22 is formed into a desired shape providing a curved drag surface 23 normal to the direction of an anticipated wind flow by being wrapped around shaping rods 24 that extend between rod anchors 25. Each shaping rod 24 is attached to the rod anchors 25 at either end of each blade section 22. The axle 21 extends between and is attached to the rod anchors 25 at either end of the turbine 20. Additional rod anchors 25 may be attached to the axle 21 in a middle portion of the turbine 20, between blade sections 22. As shown in the figures, the axle 21 extends through one of the rod anchors 25 to reach a generator 14. In other embodiments, the axle 21 may terminate at the rod anchors 25. In such embodiments wherein the axle 21 terminates at the rod anchors 25, a generator 14 may be included between the rod anchors 25.

Each shaping rod 24 preferably is made of a hollow lightweight pipe, for example, an aluminum pipe. Using lightweight shaping rods 24 may help reduce the wind speed necessary to achieve rotation of the turbine 20 at a particular target rotational speed.

The turbine 20 is adapted to rotate about the axle 21 in the direction R when the turbine 20 is exposed to a wind flow across the blade sections 22. When wind flows into the curved drag surface 23 of a blade section 22, drag forces acting on the blade section 22 cause it to rotate about the axle 21 in the direction R. Preferably, the shape of each blade section 22 includes a curved drag surface 23 to create a Savonius-type blade shape, which may have improved self-starting ability at low wind speeds compared to other blade shapes. In an alternative embodiment, the turbine may include a double-S cross-sectional shape.

To further enhance the ability of the turbine 20 to self-start, each turbine 20 includes two subsets of blade sections 22, wherein a first subset of blade sections 22 extends from a first portion of the axle 21, and a second subset of blade sections 22 extends from a second portion of the axle 21 horizontally adjacent to the first portion. Preferably, as can be most easily seen in FIG. 2A, the angles at which the first subset of blade sections 22 extends from the axle 21 are offset approximately ninety degrees (90°) from the angles at which the second subset of blade sections 22 extends from the axle 21. This configuration reduces the likelihood that the turbine will stall.

Although in the embodiments shown, each blade section 22 includes a curved drag surface 23, in other embodiments, each blade section 22 may have other shapes. For example, each turbine 20 may have a rushton turbine-type design, where each blade section 22 has a flat shape, so that each blade section 22 has a flat drag surface instead of a curved drag surface 23. Any horizontal axis radial wind turbine blade shape may be used for each turbine 20. However, it is preferred that the blade section design for each turbine 20 be of a type that has good self-start performance at low wind speeds. (i.e., rotation can begin at low wind speeds due to the presence of drag surfaces on the blade sections), such as a Savonius-type blade section shape.

Referring to FIG. 3A, a second embodiment wind turbine and housing combination 110 includes a horizontal axis radial wind turbine 120 and a housing 130 surrounding the turbine 120. The turbine 120 rotates about an axle 121 that is oriented horizontally with respect to the ground. The axle 121 is oriented substantially parallel to a longitudinal axis of an apex 111 of a gable roof 112 of a building. The turbine 120 includes a generator (shown, for example, in FIG. 1A) operatively coupled to a first end of the axle 121.

The turbine 120 further includes a plurality of blade sections 122 extending radially from the axle 121. The blade sections 122 are circumferentially spaced about the axle 121, each blade section 122 including a curved drag surface 123 that provides a stall surface normal to the direction of an anticipated wind flow. Each blade section 122 preferably is made from a lightweight fabric, such as nylon. Each blade section 122 is formed into a desired shape providing a curved drag surface 123 normal to the direction of an anticipated wind flow by being wrapped around shaping rods 124 that extend between rod anchors (shown, for example, in FIG. 2A).

As shown in FIG. 3A, there are three shaping rods 124 to provide the shape of the curved drag surface 123 of each blade section 122. In other embodiments, there may be any number of shaping rods 124 to provide the shape of the curved drag surface 123 of each blade section 122, including for example, 2, 4, 5, 6, 8, or 10 shaping rods 124. Each shaping rod 124 preferably is made of a hollow lightweight pipe, for example, an aluminum pipe. Using lightweight shaping rods 124 may help reduce the wind speed necessary to achieve rotation of the turbine 120 at a particular target rotational speed.

The turbine 120 is adapted to rotate about the axle 121 in the direction R when the turbine 120 is exposed to a wind flow across the blade sections 122. When wind flows into the curved drag surface 123 of a blade section 122, drag forces acting on the blade section 122 cause it to rotate about the axle 121 in the direction R.

Each blade section 122 preferably is made from two sheets of lightweight fabric: (i) an inner sheet providing a radially inward facing surface of the blade section 122, and (ii) an outer sheet providing a radially outward facing surface of the blade section 122. In some embodiments, a single lightweight fabric sheet may be folded over itself to serve as both the inner sheet and the outer sheet of the blade sections 122. The inner sheet and the outer sheet of each blade section 122 preferably wrap around either respective side of each shaping rod 124. The inner sheet and the outer sheet of each blade section 122 may be bonded to each other with an adhesive to attach each blade section 122 to the shaping rods 124.

The housing 130 surrounds the turbine 120 and is attached to the gable roof 112 of a building. The housing 130 includes a louver frame 131, a housing roof 132, housing attachment brackets 133 for coupling the housing 130 to the gable roof 112, a plurality of louvers 134 each coupled to the louver frame 131 at pivots 135. As shown in FIG. 3A, the bottom set of louvers 144 turn in towards turbine 20. The top two sets of louvers 140, 142 turn outward away from turbine 20. The bottom set of louvers 144 is used to direct thermal currents rising from the roof and also to direct wind. The top sets of louvers 140, 142 may be used for exhausting air current from the housing 30.

A wind speed input device such as anemometer 137 adapted to provide wind speed information that can be used to determine whether each louver 134 should be open or closed at a given moment in time. Preferably, the anemometer 137 is operatively coupled one or more motors (not shown) that are adapted to control the position of each lover 134 based on the wind speed information received by the anemometer 137.

Although in this embodiment, the wind speed input device is shown as the anemometer 137, in other embodiments, the wind speed input device may be any other type of wind speed input device, including for example, a spring that is biased to keep a particular louver 134 open or closed, alone or in combination with a stall surface included in a louver 134 (not shown). For example, a first louver 134 that is biased open by a spring may remain open at any wind speed. Alternatively, a second louver 134 that is biased closed by a spring may remain closed at low wind speeds, but if the second louver 134 also includes a stall surface above the pivot 135, the force provided against the stall surface may overcome the spring and force the second louver 134 to remain open until the wind speed decreases enough for the spring to close the second louver 134.

Referring to FIG. 3B, the louver frame 131 includes one or more compartments 136, each compartment 136 adapted to be coupled to an exterior surface of the gable roof 112 via housing attachment brackets 133 and 138. Preferably, a plurality of compartments 136 are connected in an end-to-end configuration, each compartment 136 surrounding a portion of the turbine 120.

Referring again to FIG. 3A, at the top of the turbine 120, the blade sections 122 of the turbine 120 extend above the top of the louver frame 131 into the space between the top of the louver frame 131 and the housing roof 132. Such a design, in which the blade sections extend into the space between the top of the louver frame and the housing roof, may allow the housing to have a smaller vertical height for a given diameter turbine compared to other embodiments. In other embodiments (such as the first embodiment shown in FIGS. 1A-2B), the blade sections of the turbine may remain inside the space defined by the louver frame 131 at all points during rotation of the turbine, and the space above the louver frame and below the housing roof may be unoccupied by blade sections of the turbine.

Each louver 134 is pivotable relative to the louver frame 131 by rotation about the pivot 135. Each louver 134 is capable of having (i) a closed position that prevents wind from entering the housing 130 and (ii) an open position that permits wind to enter the housing 130 such that the wind can turn the turbine 120. Each louver 134 can be moved or actuated between the closed position and an open position by one or more motors (not shown) that are operatively coupled to each of the plurality of louvers 134.

As shown in FIG. 3A, the housing 130 includes three louvers 134 on each side of the housing 130. The six louvers 134 include two primary upper louvers 140, two secondary upper louvers 142 located vertically below the primary upper louvers 140, and two lower louvers 144 located vertically below the secondary upper louvers 142 and the turbine 120 and adapted to be positioned adjacent to an exterior surface of the gable roof 112.

Preferably, the primary upper louvers 140 and the secondary upper louvers 142 are pivotable between a closed position and an open position wherein the lower end of each upper louver 140 and 142 is rotated away from the turbine 120 and outside the louver frame 131. Preferably, the lower louvers 144 are pivotable between a closed position and an open position wherein the upper end of each lower louver 144 is rotated inside the louver frame 131.

Although each upper louver 140 and 142 is shown as rotating about a pivot 135 located at the top of each upper louver 140 and 142, and each lower louver 144 is shown as rotating about a pivot 135 located at the bottom of each lower louver 144, any combination of locations of pivots 135 relative to upper louvers 140 and 142 and lower louvers 144 may be used. For example, all louvers 134 may pivot about a pivot 135 located at the top of the louvers 134, all louvers 134 may pivot about a pivot 135 located at the bottom of the louvers 134, or any combination of louvers 134 that pivot about a pivot 135 located at the top or bottom of the louvers 134 may be used in a single embodiment of the housing 130.

Whether a particular louver 134 is open or closed at any given time preferably depends on the wind speed information received by the anemometer 137 (or other wind speed input device).

For example, when the anemometer 137 detects a high wind speed, each lower louver 144 may be moved to or oriented in a closed position, while each upper louver 140 and 142 moves to an open position. Or, for example, when the anemometer 137 detects a high wind speed, each lower louver 144 and each secondary upper louver 142 (located adjacent to each lower louver 144) may be moved to a closed position, while each primary upper louver 140 moves to an open position. Or, for example, when the anemometer 137 detects a high wind speed all of the louvers 134 may be moved to or oriented in an open position.

Alternatively, when the anemometer 137 detects a low wind speed, each lower louver 144 may be moved to or oriented in an open position, while each upper louver 140 and 142 remains in a closed position. Or, for example, when the anemometer 137 detects a low wind speed, each lower louver 144 and each secondary upper louver 142 (located adjacent to each lower louver 144) may be moved to an open position, thereby forming an air channel between each lower louver 144 and each adjacent secondary upper louver 142. Such an air channel may constrict the air passing into the housing 130, which may increase the pressure in the air entering the housing 130 so that more force is applied to the curved drag surfaces 123 for a given entering air volume, thereby increasing the speed of rotation of the turbine 120.

Specifically, such an air channel created between a lower louver 144 and an adjacent secondary upper louver 142 may provide a nozzle effect on air currents entering the housing 130, which may force air into the housing 130 with increased pressure. The reduction in cross-sectional area of the air current entering the housing 130 through the air channel may create air compression in the channel. Compression of the air current in the channel created by a lower louver 144 and an adjacent secondary upper louver 142 may increase the pressure in an air current entering the housing 130. This increased pressure of air entering the housing 130 may provide more force against the curved drag surfaces 123, thereby increasing the speed of rotation of the turbine 120 from a given wind current.

Such low wind speed configurations, which may open each lower louver 144 and that may form an air channel between each lower louver 144 and each adjacent secondary upper lover 142, may be configured to take advantage of anticipated thermal air currents moving upward along the surfaces of the gable roof 112 from the lower edges towards the apex 111, thereby allowing the turbine 120 to rotate and generate energy, even in the absence of a wind field having a significant non-zero velocity.

For example, when it is sunny outside, but in the absence of a wind field having a significant non-zero velocity, the sun may heat the surface of the gable roof 112. Such heating of the gable roof 112 may cause a thermal air current, wherein the hot gable roof 112 heats the air close to the surface of the gable roof 112 via conduction. The lower density heated air rises along the surface of the gable roof 112 relative to the higher density colder air further away from the surface of the gable roof 112. Such a thermal air current may rise along the hot gable roof 112 towards the apex 111, even in the absence of wind. The motion of the thermal air current that enters the housing 130, for example, via the lower louver 144 or via an air channel between a lower louver 144 and an adjacent secondary upper louver 142, may be sufficient to rotate the turbine 120 and produce electricity for the building on which the combination 110 is mounted. For weather conditions that give rise to little breeze and thermal currents rising from the roof, the bottom set of louvers 144 opens inward directing current towards the turbine 20 and the top sets of louvers 140, 142 on the windward side will stay closed. In the configurations shown in FIGS. 4A and 4B, the bottom set of louvers will be opened to direct thermal currents and the top set of louvers will be closed on the windward side. In both embodiments, the louvers on the leeward side of the housing 30 may be opened or slightly opened to allow air flow out of the housing.

To further take advantage of thermal air currents to drive or help drive the turbine 120, warm air located in an interior 150 of the gable roof 112 (compared to cooler air outside) may be permitted to flow into the housing 130 through one or more apertures 152 located underneath the housing 130 and/or one or more apertures 154 located outside of and vertically below the housing 130. Heating of the gable roof 112 may heat the air located in the interior 150 close to the surface of the gable roof 112 via conduction. The lower density heated air rises through the apertures 152 and/or 154 relative to the higher density colder air located outside of gable roof 112, thereby allowing each aperture 152 and/or 154 to emit a convection current of air into the housing 130. Such a thermal air current may rise through the hot gable roof 112 towards the housing 130, even in the absence of wind.

To assist in directing thermal currents through an aperture 154 into the housing 130, a guide 156 may be used to deflect thermal air currents flowing through an aperture 154 towards an air channel located between an open lower louver 144 and an open adjacent secondary upper louver 142.

As shown in FIG. 3A, the turbine 120 will always rotate in a counter-clockwise direction R about axle 121, no matter which direction the wind field enters the housing 130. This counter-clockwise rotation R is due to the orientation of the curved drag surfaces 123 of each blade section 122 relative to the axle 121. When a wind field enters the housing 130, the force of the wind acting on the curved drag surface 123 of each blade section 122 will cause a counter-clockwise torque that rotates the turbine 120 about the axle 121 in the counter-clockwise direction R. In other embodiments, the curved drag surfaces 123 of each blade section 122 may be switched relative to the axle 121, such that the turbine 120 will always rotate in a clockwise direction about axle 121. Whether the turbine 120 is installed in the housing 130 to rotate in a clockwise or a counter-clockwise direction may depend on the particular geometry of the anticipated wind flows near the apex 111 of the gable roof 112.

Because the turbine 120 will always rotate in a counter-clockwise direction R about the axle 121, it may be beneficial to open or close particular louvers 134 independently of the other louvers 134, depending on the velocity and direction of the wind field detected by the anemometer 137.

For example, with reference to FIG. 3A, if the wind is blowing at a high speed (approximately 30 miles per hour) from right to left, all three sets of louvers 140, 142, 144 on the windward side of housing 130 may be moved to an open position. Similarly, in the embodiments shown in FIGS. 1A, 1B, 4A, 4B, all two sets of louvers may be in the open position. As can be seen in FIG. 3A, if the primary upper louver 140 on the right side of the housing 130 is open, wind can blow directly into the curved drag surface 123 of the top blade section 122, thereby causing the turbine 120 to rotate counter-clockwise. In such a situation, a louver 134 on the left side of the housing 130, for example the secondary upper louver 142, may be moved to an open position to vent the wind out of the housing 130 after the top blade section 122 has rotated vertically below the axle 121. Alternatively, in some embodiments, the wind may be vented out of the housing roof 132 of the housing 130 through a louver positioned in the housing roof 132 (not shown).

Alternatively, if the wind is blowing at a high speed from left to right, a first secondary upper louver 142 on the left side of the housing 130 may be moved to an open position, while a second secondary upper louver 142 on the left side of the housing 130 may remain in a closed position. As can be seen in FIG. 3A, if the secondary upper louver 142 on the left side of the housing 130 is open, wind can blow directly into the curved drag surface 123 of the bottom blade section 122, thereby causing the turbine 120 to rotate counter-clockwise. In such a situation, a louver 134 on the right side of the housing 130, for example the primary upper louver 140, may be moved to an open position to vent the wind out of the housing 130 after the top blade section 122 has rotated vertically above the axle 121. Alternatively, in some embodiments, the wind may be vented out of the housing roof 132 of the housing 130 through a louver positioned in the housing roof 132 (not shown).

On the other hand, if the wind is not blowing with a significant non-zero velocity, a lower louver 144 and a secondary upper louver 142 on the right side of the housing 130 may be moved to an open position to create an air channel for a thermal air current, while the corresponding lower louver 144 and secondary upper louver 142 on the left side of the housing 130 may remain in a closed position. As can be seen in FIG. 3A, if the lower louver 144 and the secondary upper louver 142 on the right side of the housing 130 are open, a thermal current may blow into the curved drag surface 123 of the top blade section 122, thereby causing the turbine 120 to rotate counter-clockwise. In such a situation, a louver 134 on the left side of the housing 130, for example the primary upper louver 140, may be moved to an open position to vent the wind out of the housing 130 after the top blade section 122 has rotated vertically below the axle 121. Alternatively, in some embodiments, the wind may be vented out of the housing roof 132 of the housing 130 through a louver positioned in the housing roof 132 (not shown).

In other weather conditions, the louvers may be adjusted accordingly. For example, on a moderately windy day, with wind speeds at approximately 10 miles per hour, the bottom louver may be completely open and the middle or top louver may be partially open on the windward side. Similarly, in very windy conditions such as when the wind is blowing at approximately 60 miles per hour, the louvers may only be cracked slightly to allow for rotation of the turbine 20 but to protect the turbine from the full force of the wind.

Referring to FIG. 4C, there is provided is a perspective view of another embodiment of a wind turbine integrated within a gable roof of a building, such as in new home construction. The louvers of this wind turbine system are integrated directly within the gable roof. The horizontal turbine is integrated within the housing within what would normally be the attic space within the gable roof Louvers are actuated as described elsewhere to permit the wind, thermal currents, or both, to enter the attic space and turn the turbine blades, which in turn through an optional gearing system, turns a suitable generator to generate electricity.

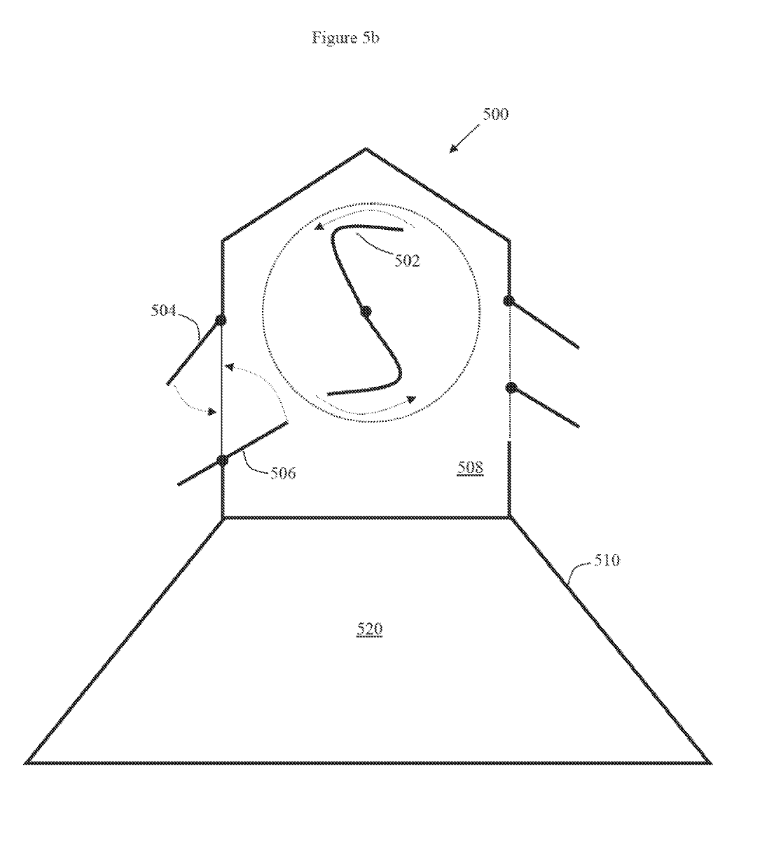

Referring to FIG. 5A, there is provided a cross sectional end view of another embodiment of a wind turbine integrated within a cupola of a building which shows the details of the louvers and louver actuators. The louvers of this wind turbine system are integrated directly within the cupola. The horizontal turbine is integrated within the housing within the cupola. Louvers are actuated using a suitable linear or rotating motor coupled to one or more louvers using one or more actuator arms. The louvers being opened permits the wind, thermal currents, or both, to enter the cupola and turn the turbine blades, which in turn through an optional gearing system, turns a suitable generator to generate electricity. The bottom louver opens inward to the cupola to allow the harvest of air currents, thermal currents, or both to be channeled from the gable roof into the cupola to turn the turbine to turn the generator to generate electricity.

Referring to FIG. 5B, there is provided a cross sectional end view of another embodiment of a wind turbine integrated within a cupola of a building which shows the details of certain louvers directed into the cupola to give rise to greater turbine rotational speed. The wind turbine housing combination 500 comprises a turbine 502 mounted within cupola 508. On one side of the cupola there is provided a louver 504 for controlling the opening of the side of the cupola (left side in this drawing) for permitting wind to enter the cupola turn the turbine. Air then exits through louvers on the opposite side of the cupola. Internally extending louver 506 is shown being capable of not only extending outside of the cupola for permitting the entrance of air, but also extends inwards to the turbine blades within the cupola to deliver wind directly to the vicinity of the turbine blades. Cupola 508 sits atop gable roof 510 having attic space 520.

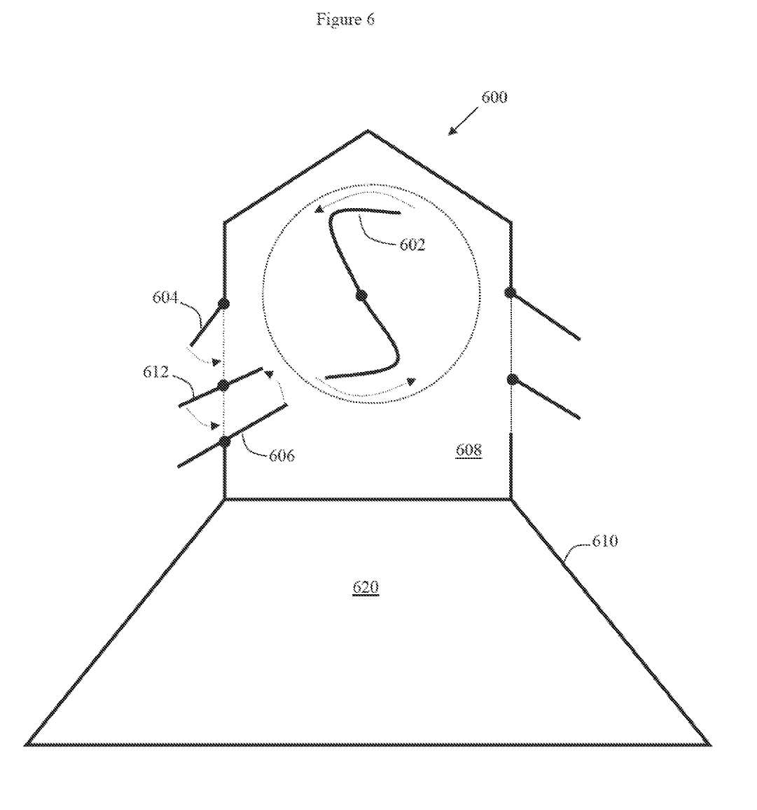

Referring to FIG. 6, there is provided a cross sectional end view of another embodiment of a wind turbine integrated within a cupola of a building which shows the details of certain louvers directed into the cupola to give rise to greater turbine rotational speed. The wind turbine housing combination 600 comprises a turbine 602 mounted within cupola 608. On one side of the cupola there are provided a louver 604 for controlling the opening of the side of the cupola (left side in this drawing) for permitting wind to enter the cupola turn the turbine. Air then exits through louvers on the opposite side of the cupola. Internally extending louver 606 is shown being capable of not only extending outside of the cupola for permitting the entrance of air, but also extends inwards to the turbine blades within the cupola to deliver wind directly to the vicinity of the turbine blades. Also provided is a second internally extending louver 612 positioned between louvers 604 and 606. The second internally extending louver 612 is capable of being independently controlled relative to internally extending louver 606 to form a smaller opening inside the cupola to increase the wind speed on the turbine. Without being limited to any theory of operation, it is believed that the venturi effect operates to increase air speed in a narrowing region provided by the two internally extending louvers 606 and 612. Cupola 608 sits atop gable roof 610 having attic space 620.

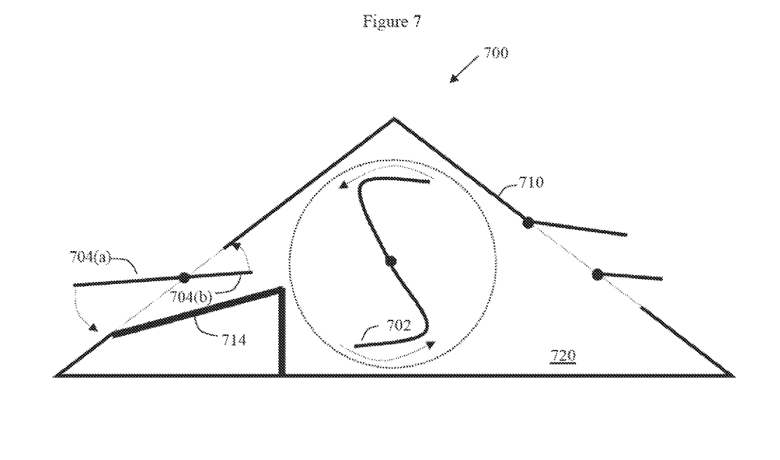

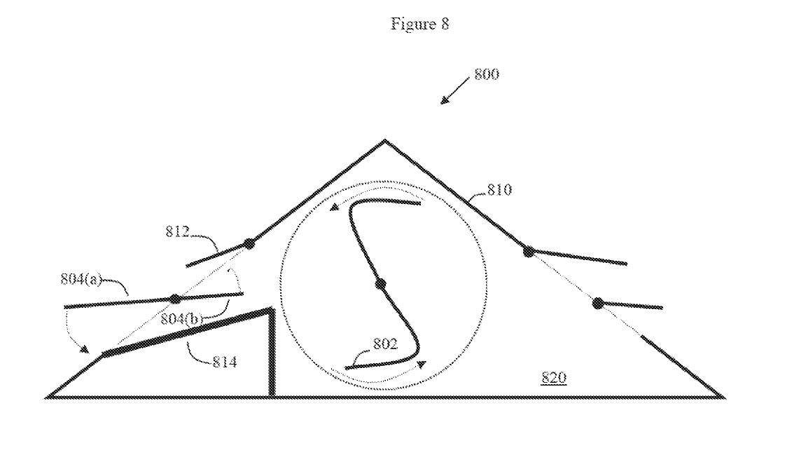

Referring to FIG. 7, there is provided a cross sectional end view of another embodiment of a wind turbine integrated within a gable roof of a building which shows the details of certain louvers directed into the gable roof to give rise to greater turbine rotational speed. The wind turbine housing combination 700 comprises a turbine 702 mounted within roof gable 720, which is typically an attic space, accessible or not accessible. On one side of the roof gable there is provided a louver 704 for controlling the opening of the side of the roof (left side in this drawing) for permitting wind to enter the roof gable to turn the turbine. Air then exits through louvers on the opposite side of the roof gable. Externally-internally extending louver 704(a-b) is shown having two portions 704(a) for the externally extending portion and 704(b) for the internally extending portion. Thus, externally-internally louver 704(a-b) is shown being capable of not only extending outside of the roof gable for permitting the entrance of air, but also extends inwards to the turbine blades within the attic space to deliver wind directly to the vicinity of the turbine blades. A wind channel surface 714 sits with the attic space of the roof gable to form a narrowing wind channel with the internally extending portion 704(b) of the louver. The narrowing wind channel forms a smaller opening inside the roof gable to increase the wind speed on the turbine. Without being limited to any theory of operation, it is believed that the venturi effect operates to increase air speed in the narrowing wind channel. Externally-internally louver 704(a-b) also provides an opening above the pivot point for permitting the entrance of additional air as a result of the venturi effect to further increase the amount of wind on the turbine for increasing torque.

Referring to FIG. 8, there is provided a cross sectional end view of another embodiment of a wind turbine integrated within a gable roof of a building which shows the details of certain louvers directed into the roof to give rise to greater turbine rotational speed. The wind turbine housing combination 800 comprises a turbine 802 mounted within roof gable 820, which is typically an attic space, accessible or not accessible. On one side of the roof gable there is provided an externally-internally extending louver 804(a-b) for controlling the opening of the side of the roof (left side in this drawing) for permitting wind to enter the roof gable to turn the turbine. Air then exits through louvers on the opposite side of the roof gable. Externally-internally extending louver 804(a-b) is shown having two portions 804(a) for the externally extending portion and 804(b) for the internally extending portion. Thus, externally-internally louver 804(a-b) is shown being capable of not only extending outside of the roof gable for permitting the entrance of air, but also extends inwards to the turbine blades within the attic space to deliver wind directly to the vicinity of the turbine blades. A wind channel surface 814 sits with the attic space of the roof gable to form a narrowing wind channel with the internally extending portion 804(b) of the louver. The narrowing wind channel forms a smaller opening inside the roof gable to increase the wind speed on the turbine. Without being limited to any theory of operation, it is believed that the venturi effect operates to increase air speed in the narrowing wind channel. Externally-internally louver 804(a-b) also provides an opening above the pivot point for permitting the entrance of additional air as a result of the venturi effect to further increase the amount of wind on the turbine for increasing torque. The size of this opening can be controlled using louver 812.

The foregoing description is provided for the purpose of explanation and is not to be construed as limiting the invention. While the invention has been described with reference to preferred embodiments or preferred methods, it is understood that the words which have been used herein are words of description and illustration, rather than words of limitation. Furthermore, although the invention has been described herein with reference to particular structure, methods, and embodiments, the invention is not intended to be limited to the particulars disclosed herein, as the invention extends to all structures, methods and uses that are within the scope of the appended claims. Further, several advantages have been described that flow from the structure and methods; the present invention is not limited to structure and methods that encompass any or all of these advantages. Those skilled in wind turbine technology, having the benefit of the teachings of this specification, may effect numerous modifications to the invention as described herein, and changes can be made without departing from the scope and spirit of the invention as defined by the appended claims. Furthermore, any features of one described embodiment can be applicable to the other embodiments described herein. For example, any features or advantages related to the design of the turbine housing with respect to discussion of a particular wind turbine embodiment can be applicable to any of the other wind turbine embodiments described herein.

1.-33. (canceled)

34. A wind turbine and housing combination, comprising:
a horizontal axis radial wind turbine, the turbine including:
an axle;
a plurality of blade sections extending radially from the axle, the blade sections circumferentially spaced about the axle, each blade section including a curved drag surface that provides a stall surface normal to the direction of an anticipated wind flow; and
a generator operatively coupled to a first end of the axle, the generator adapted to produce electricity when the axle is rotated; and
a housing surrounding the turbine, the housing including:
a plurality of louvers, each louver coupled to the louver frame, each louver pivotable relative to the housing, each louver capable of having (i) a closed position that prevents wind from entering the housing and (ii) an open position that permits wind to enter the housing; and
a motor operatively coupled to the plurality of louvers, the motor adapted to move each louver between the closed position and the open position;
whereby the wind turbine is adapted to be incorporated within a cupola or a gabled roof of a building.

35. The combination of claim 34, wherein each louver pivots relative to the axle about a pivot axis oriented substantially parallel to the axle.

36. The combination of claim 34, wherein a first subset of the plurality of louvers is located on a first side of the axle, and a second subset of the plurality of louvers is located on a second side of the axle opposite the first side.

37. The combination of claim 36, wherein each subset of the plurality of louvers includes three louvers.

38. The combination of claim 36, wherein each subset of the plurality of louvers includes a lower louver located vertically below the turbine and adapted to be positioned adjacent to a surface of the gable roof.

39. The combination of claim 38, further comprising an opening in the gable roof adapted to emit a convection current of air into the housing.

40. The combination of claim 38, further comprising an anemometer operatively coupled to the motor, the anemometer adapted to provide wind speed information to the motor.

41. The combination of claim 40, wherein each subset of the plurality of louvers further includes an upper louver located adjacent to the lower louver and adapted to be positioned by the motor to form an air channel with the lower louver when the anemometer detects a low wind speed.

42. The combination of claim 34, wherein each blade section is made from a lightweight fabric.

43. The combination of claim 34, wherein a first subset of the plurality of blade sections extends from a first portion of the axle, and a second subset of the plurality of blade sections extends from a second portion of the axle horizontally adjacent to the first portion.

44.-55. (canceled)

56. A wind turbine system, comprising:
a horizontal axis radial wind turbine, the turbine including:
an axle;
a plurality of blade sections extending radially from the axle, the blade sections circumferentially spaced about the axle, each blade section including a curved drag surface that provides a stall surface normal to the direction of an anticipated wind flow; and
a generator operatively coupled to a first end of the axle, the generator adapted to produce electricity when the axle is rotated;
a housing surrounding the turbine and integrated with a cupola or a gable roof of a building, the housing including:
a plurality of louvers, each louver coupled to the louver frame, each louver pivotable relative to the housing, each louver capable of having (i) a closed position that prevents wind from entering the housing and (ii) an open position that permits wind to enter the housing; and
a motor operatively coupled to the plurality of louvers, the motor adapted to move each louver between the closed position and the open position, and
the cupola or gable roof of the building;
whereby a first louver and a second louver of the plurality of louvers are adapted to form a channel to direct a thermal air current flowing along the gable roof into an underside of the turbine.

57. The system of claim 56, further comprising an anemometer operatively coupled to the motor, the anemometer adapted to provide wind speed information to the motor.

58. The system of claim 56, wherein the first louver is a lower louver located vertically below the turbine and adapted to be positioned adjacent to a surface of the gable roof, and the second louver is an upper louver located adjacent to the lower louver

59. The system of claim 56, further comprising an opening in the gable roof adapted to emit a convection current of air into the channel.

60. The system of claim 56, wherein each louver pivots relative to the axle about a pivot axis oriented substantially parallel to the axle.

61. The system of claim 56, wherein a first subset of the plurality of louvers is located on a first side of the axle, and a second subset of the plurality of louvers is located on a second side of the axle opposite the first side.

62. The system of claim 61, wherein each subset of the plurality of louvers includes three louvers.

63. The system of claim 56, wherein each blade section is made from a lightweight fabric.

64. The system of claim 56, wherein the turbine further includes a second generator operatively coupled to a second end of the axle opposite the first end of the axle.

65. (canceled)

66. A method of harnessing energy from wind, thermal currents, or both, the method comprising:
positioning one or more of a plurality of louvers coupled to a housing surrounding a radial wind turbine generator in response to wind and temperature conditions, the housing being incorporated with a cupola or gable roof of a building;
directing wind, thermal air currents, or both, through the position of the louvers to rotate a plurality of blade sections extending radially from an axle of the radial wind turbine; and
generating electricity from the rotation of the radial wind turbine.
